(19) United States
(12) Patent Application Publication
(10) Pub. No.: US 2007/0245625 A1
(43) Pub. Date: Oct. 25, 2007

(54) Window-mounted planter

(76) Inventor: Christian Lennon, Blue Point, NY (US)

Correspondence Address: HOFFMANN & BARON, LLP, 6900 JERICHO TURNPIKE, SYOSSET, NY, 11791, US

(21) Appl. No.: 11/406,969

(22) Filed: Apr. 19, 2006

(51) Int. Cl. A01G 9/02

(52) U.S. Cl. 47/67; 47/68

(57) ABSTRACT

A planter is provided, which includes a container for holding plants, which is mounted on a window pane from attachment positions outside the periphery of the container's silhouette on the window. The container includes a planar surface that rests against the window. At least two mounting elements, e.g., suction cups, attach to the window. The container is hung from a flexible strand(s) which loop through and/or terminate at rings or apertures on the container. The other end of the strand(s) attaches to the mounting elements. The horizontal and/or vertical positioning of the container can be adjusted in situ. The planter can include a plurality of containers hung in various configurations from two or more mounting elements. The containers can be formed from (synthetic) stained glass, ceramic, or other decorative material and filled with clear or colored synthetic soil. The flexible strands are also decorative and formed, for example, from macramé.

### FIELD OF THE INVENTION

The present invention relates generally to surface-mounted planters for holding indoor plants and, more particularly, to aesthetically pleasing and easily adjustable window-mounted planters.

### BACKGROUND OF THE INVENTION

Conventional planters for containing and growing plants are typically of either a rectangular box or cylindrical shape and include a horizontal bottom surface for supporting the planter on a horizontal surface. Naturally, the planters are typically kept on a window sill or nearby surface for exposure to natural sunlight.

Hanging planters are known for hanging plants from ceilings to better access sunlight and avoid clutter on window sills and tabletops. For example, U.S. Pat. No. 5,052,148 to Sharon, et al., discloses multiple vertically hanging pots attached together by hanging rope which is attached to a ceiling. Wall-mounted planters similarly provide a means of keeping plants thriving indoors while providing an aesthetically pleasing room décor. U.S. Pat. No. 3,978,612 to Young, for example, discloses a flower pot holder that can be mounted to the frame of a window sash.

U.S. Pat. No. 6,625,927 to Woodruff discloses a quarter-spherical planter with a container or receptacle for receiving plants that is permanently attached to a vertical back panel. The vertical back panel is rigidly mountable to a window pane using one or more vertically positioned suction cups mounted to the back of the vertical back panel. The back panel also has a watering reservoir. The planter provides plants access to sunlight using a vertical surface-mounted back panel that does not require the planter to rest on a horizontal surface. However, the rigid and bulky mounting arrangement also detracts from the aesthetics of the planter and obscures one's view through the window.

There is a need, therefore, that is unfulfilled by the prior art, for an improved window-mounted planter that is easily and adjustably mountable to a window pane, while simultaneously providing an aesthetically pleasing and functional window-mounted planter.

### SUMMARY OF THE INVENTION

The present invention, which addresses the needs of the prior art, relates to window-mounted planters that are easily and adjustably mountable to a window pane, while simultaneously providing an aesthetically pleasing and functional window-mounted planter.

The present invention is a planter for mounting on a window pane which includes a container for holding plants having a planar surface that rests against a window pane. The container defines a silhouette, which has a periphery, on the window pane. The planter further includes at least two mounting elements operatively connected to the container and attachable to the window pane from positions of attachment outside the periphery of the silhouette. The mounting elements support the container with the planar surface resting against the window pane.

The present invention also includes a planter for mounting to a window plane which has a plurality of containers for holding plants. Each container includes a planar surface that rests against a window pane and defines a silhouette with a periphery on the window pane. The planter also includes a plurality of mounting elements capable of mounting the containers onto the window pane. Each container is operatively connected to two of the mounting elements. The mounting elements are attachable to the window pane from positions of attachment outside the periphery of the silhouette and support each container with its planar surface resting against the window pane. The planter further includes at least one flexible strand for attaching the containers to, and hanging them from, the mounting elements.

The mounting elements of the present invention can be suction cups.

The at least one flexible strand can include string, rope, wire, twine, hemp, macramé, or leather.

In addition, the strand(s) can be adjustable in length. The length adjustment can be provided, for example, by a draw-string and slidable locking clasp, which allows a number of containers to be hung from and between two mounting elements. Each such container is positioned at a different height by appropriate adjustment of the adjustable-length flexible strand.

The planter can also include positioning clips for locating and maintaining the containers at a preferred position along the at least one flexible strand.

The present invention further includes a combination of a window-mounted planter that has a container for holding plants, clear or colored synthetic soil retained within the container for potting the plants, seeds, and a measuring cup for measuring water for watering the plants. The planter also includes at least two mounting elements operatively connected to the container. The container includes a planar surface that rests against a window pane and defines a silhouette, which has a periphery, on the window pane. The mounting elements are attachable to the window pane from positions of attachment outside the periphery of the silhouette and support the container with its planar surface resting against the window pane.

As a result, the present invention provides a window-mounted planter that is easily and adjustably mountable to a window pane, functional, and aesthetically pleasing.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a schematic representation of an embodiment of a window-mounted planter formed in accordance with the present invention.

FIG. 2 is a side-view of a container of the window-mounted planter of FIG. 1.

FIG. 3 is a schematic representation of another embodiment of a window-mounted planter formed in accordance with the present invention.

FIG. 4 is a schematic representation of yet another embodiment of a window-mounted planter formed in accordance with the present invention.

FIG. 5 is a side-view of one container of the window-mounted planter of FIG. 4.

FIG. 6 is a schematic representation of still another embodiment of a window-mounted planter formed in accordance with the present invention.

### DETAILED DESCRIPTION OF THE INVENTION

The present invention provides an aesthetically pleasing and functional window mounted planter which is easily and adjustably mountable to a window pane.

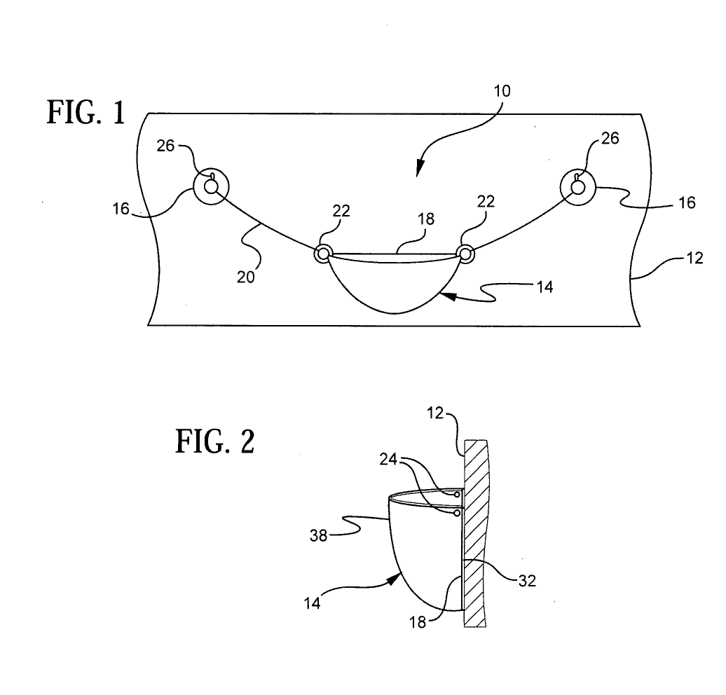

Referring to FIG. 1, a planter 10 for mounting on a window pane 12 formed in accordance with the present invention includes a container 14, preferably water-tight, for holding a plant and at least two mounting elements 16. Referring also to FIG. 2, the container 14 includes a planar surface that rests against the window pane 12 when mounted.

The mounting elements 16 are operatively connected to the container 14 and are attachable to the window pane 12 from positions of attachment outside the periphery of the silhouette defined by the container 14 on the window pane 12. This arrangement of mounting elements 16 supports the container 14 and maintains the planar surface 18 resting against the windowpane 12.

The planter 10 also preferably includes at least one flexible strand 20 with one end integrated into, or attached and secured to each of the at least two mounting elements 16 by securing with a knot, for example, or by other methods known to those skilled in the art, such as gluing with a suitable epoxy. Preferably, each mounting element 16 includes an attaching element 26, such as an integral hook, ring, or aperture to which the flexible strand can be looped, tied, or otherwise attached and secured.

Preferably, two rings or loops 22 are provided on the container 14, one on each end of the upper edge of the container 14. The rings 22 can be formed from any suitable material, such as metal or fabric. The rings 22 can be solid and integral to the container and flush with one of the surfaces of the container. Optionally, the rings 22 can protrude from the container as shown in FIG. 1, and can also be adapted according to methods known to those skilled in the art to be removable through reinforced apertures 24 provided at the upper edge of the container 14. For example, the rings 22 can be clasps which can open and close around both the reinforced apertures 24 and a terminating loop formed at the end of the strand 20. Optionally, the strand(s) can attach directly to the reinforced apertures 24.

In one embodiment, the at least one strand 20 is one strand used to attach the container 14 to the mounting elements 16. The strand is laced through both rings 22 or apertures 24. Each end of the strand is fixed to one of the mounting elements 16 as described above. The mounting elements are attached to the window pane 12 on either side of the container 14. The container 14 is preferably centered between two horizontally positioned mounting elements 16. The vertical position of the container 14 can be adjusted by relocating the vertical position of the mounting elements 16 and/or by adjusting the horizontal spacing between the mounting elements 16.

Optionally, the mounting elements 16 do not lie on the same horizontal line, and the container 14 is appropriately positioned along the strand so that the container 14 stays level. Slidable locking clasps can also be provided on either side of the container 14 to adjust and maintain the horizontal positioning of the container 14 in situ.

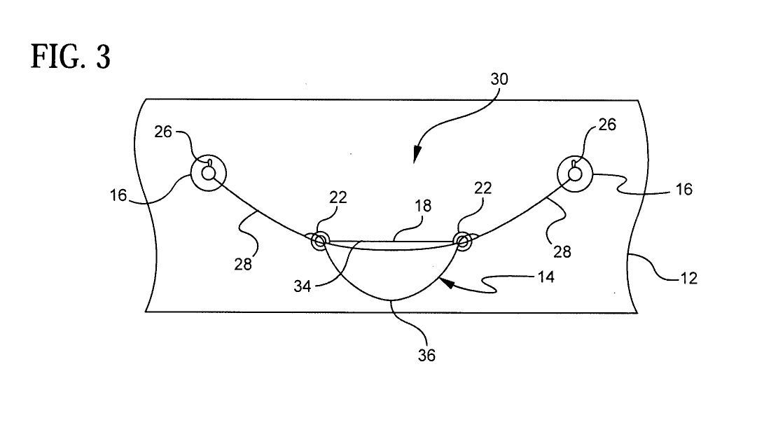

In a second embodiment 30, shown in FIG. 3, the at least one strand 20 includes two separate strands 28, one for each mounting element 16. One end of each strand 28 is integrated into or attached to one of the mounting elements 16 as described above, and the other end is secured to one of the rings 22, which can include a releasable clasp, or apertures 24 on the container 14 by any suitable method known to those skilled in the art, including securing with a knot, or gluing with a suitable epoxy. Additionally, the strand 28 can be terminated at one end in a knot, or in a loop for hooking onto the ring 22, preferably using a releasable clasp, on the container 14.

The flexible strand(s) of the present invention can include any suitable material known to those skilled in the art including, but not limited to, string, rope, twine, hemp, yarn, wire, and leather to attach the planter to the at least one mounting element, and which allow the planter to hang from the mounting elements 16.

Preferably, the flexible strand is decorative as well as functional. In one embodiment, the flexible strand is formed by macramé, a form of textile-making well-known to those skilled in the art which uses knotting rather than weaving or knitting. In addition to cotton twine, hemp, leather or yarn arranged in decorative knots, the macramé strand can also include beads, shells, gemstones, and so on, which can be secured by wire-wrapping or other known methods.

In a preferred embodiment, the mounting elements 16 are suction cups, which are preferably transparent. The suction cups can be any suitable suction cups known in the art for mounting to a window pane and capable of supporting the container 14, and which can be adapted for attaching to one end of a flexible strand 20 of the present invention. Preferably, the suction cups include the attaching element 26 described above, such as an integral hook, ring, or aperture to which the flexible strand can be looped, tied, or otherwise attached.

In another embodiment, the mounting elements 16 can include fastening strips attached to at least one end of the strand 20 for mounting to reciprocal fastening strips attached to said window pane. The fastening strips and reciprocal fastening strips can be, for example, VELCRO®, and are preferably transparent or translucent. The reciprocal strips are preferably fixed to the window pane 12 using any suitable glue or epoxy known to those skilled in the art which can be safely removed at a later time if desired.

The container 14 is also preferably colorful and decorative, as well as functional, capable of holding both soil and water for growing plants. The container 14 of the present invention can be hollow or a thinly-walled solid and can be clear or opaque. Preferably, the container is formed from a light-weight material, and can include clear or colored plastic, ceramic, glass, or terracotta. For a more decorative look, stained glass or synthetic stained glass can be used.

In another embodiment, the container can be formed of a biodegradable material so that the entire pot can be planted outside at a later date. Any variety of plants, including flowers or herbs can be maintained in the container, which can, of course, also hold potting soil in which the plants are planted.

In yet another embodiment, the container can be filled with a clear or colored synthetic soil for potting plants.

A kit formed in accordance with the present invention, therefore, includes the planter 10 of the present invention, synthetic soil of one or various colors and transparency, seeds for planting, and a measuring cup for adding an appropriate amount of water to the container.

Referring particularly to FIG. 2, the planar surface 18 of the container 14 is substantially flat for resting the container 14 flat against a window pane 12. For use with poorly insulated windows, the container 14 can also include a thin layer of insulating material 32, such as an insulating foam, insulating epoxy, or any other material known to those skilled in the art, which can be fixed to or integrated into the portion of the inside wall or outside wall (as shown in FIG. 3, on planar surface 18) proximate the window pane 12.

One skilled in the art will appreciate that the container of the present invention can be of any shape suitable for holding plants with soil and water, and which includes a planar surface for resting against a window pane. The container can be formed as one continuous seamless form, or can include different sections which are attached to one another according to any methods known to those skilled in the art.

The container 14 shown in FIGS. 1-3 is in the shape of a truncated portion of an ellipsoid or spherical volume. In particular, with reference to FIG. 3, the planar surface 18 preferably includes an upper flat edge 34 which is continuous with a curved edge 36 to form, for example, a truncated circle or ellipse. Referring to FIG. 2, a continuous rounded surface 38 joins the curved edge to form a pocket in the container 14 in which the plants are held.

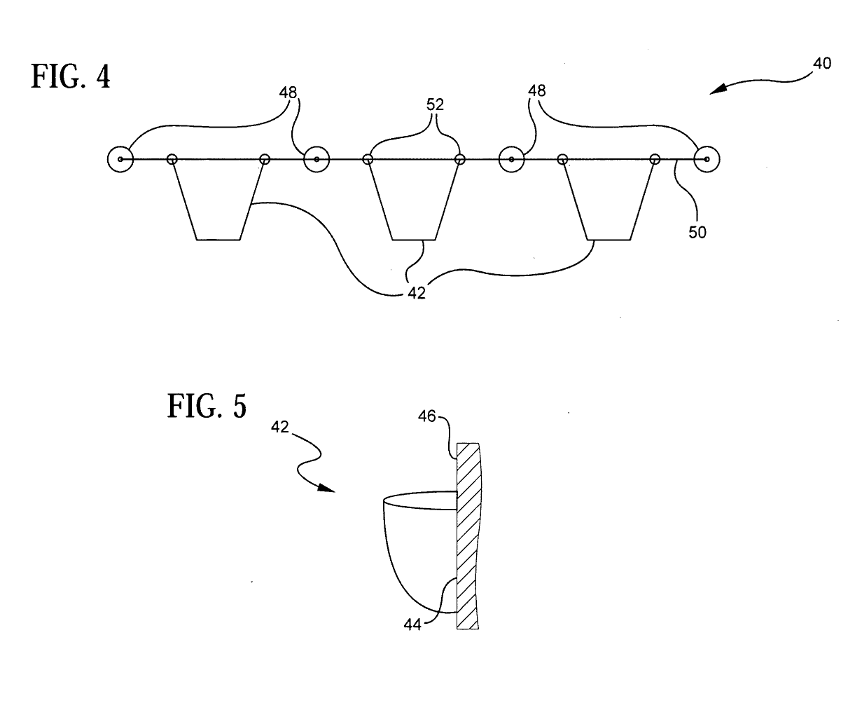

Other shapes include, but are not limited to, a “window-box” shaped planter, and a half of a traditional flower pot (see FIGS. 4 and 5). For example, the planar surface can be in the shape of a quadrilateral, such as a rectangle or trapezoid. A four-sided structure, having two side surfaces, a bottom surface, and a front surface, joins the planar surface to form an open box-like window-mounted planter. One skilled in the art will appreciate that any number of other shapes can be used.

Certain types of plants, including particular herbs, need a moist, covered environment, at least when first planted. Therefore, the planter of the present invention can include a clear plastic domed lid for attaching to the container as needed. To accommodate the lid, the container of the present invention can also include a rim, or a groove preferably around the upper inside surface of the container, for holding such a lid in place.

Referring to FIG. 4, another embodiment 40 of the planter of the present invention includes a plurality of containers 42 for holding plants. Referring also to FIG. 5, each container 42 includes a planar surface 44 that rests against a window pane 46. The container 42 defines a silhouette on the window pane 46.

The planter 40 includes a plurality of mounting elements 48, preferably suction cups, which are attachable to the window pane 46 from positions of attachment outside the periphery of the silhouette. As shown in FIG. 4, each container 42 is operatively connected to two of these mounting elements 48, which support each container with the planar surface 44 resting against the window pane 46. The planter 40 also includes at least one flexible strand 50 for attaching the containers 42 to the mounting elements 48.

As shown in FIG. 4, the containers 42 can be horizontally positioned in an adjacent fashion. In one embodiment, the at least one flexible strand 50 can include a single strand for each container 42, which is laced through two rings 52 provided on the containers 42 and which is attached on either end to one of the mounting elements 48, in a similar manner as described above in reference to the embodiment shown in FIG. 1. Alternatively, a pair of flexible strands can be provided for each container 42. Each of the pair of flexible strands attaches to one of the rings 52 or to apertures provided in the container, using any suitable method known to those skilled in the art, including securing with a knot, gluing with a suitable epoxy, or hooking onto the rings 52 using a releasable clasp as described above with reference to FIG. 3.

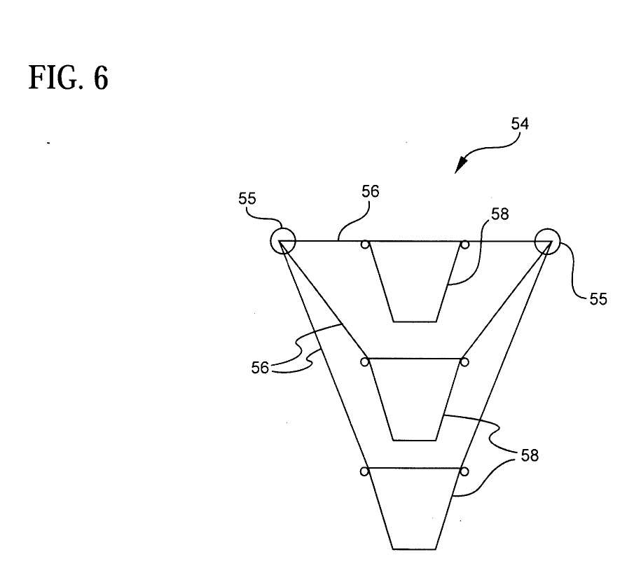

Referring to FIG. 6, another embodiment of a planter 54 formed in accordance with the present invention includes two mounting elements 55 and one or a pair of flexible strands 56 corresponding to each container 58. The containers 58 are hung between the two mounting elements 55 at different vertical positions by adjusting the flexible strands or pairs of strands to different lengths.

The flexible strand used in any of the embodiments described above can be provided with adjustability in length using any method known to those skilled in the art, including using a slidable locking clip or clasp in a draw-string arrangement to adjust the length. Therefore, the vertical positioning of the container(s) can be adjusted in situ on the window pane.

Although illustrative embodiments of the present invention have been described herein with reference to the accompanying drawings, it is to be understood that the invention is not limited to those precise embodiments, and that various other changes and modifications can be effected therein by one skilled in the art without departing from the scope or spirit of the invention.

1. A planter for mounting on a window pane, comprising:
a plant container having a pocket adapted to hold plants, said container comprising an upper edge and a planar surface that rests against a window pane and at least one of a ring or an aperture positioned on said upper edge of said container for attachment to said window pane, said container defining a silhouette having a periphery on said window pane; and
at least two mounting elements operatively connected to said at least one ring or aperture on said upper edge of said container and attachable to a window pane from positions of attachment outside said periphery to support said container with said planar surface resting against said window pane.

2. The planter of claim 1, further comprising at least one flexible strand attached to each of said at least two mounting elements and to said container for hanging said container from said at least two mounting elements.

3. The planter of claim 2, wherein said at least one flexible strand is looped through said ring or aperture.

4. The planter of claim 2, further comprising a plurality of flexible strands and a plurality of rings or apertures, wherein each of said plurality of strands is terminated at each of said plurality of rings or apertures.

5. The planter of claim 1, wherein the at least two mounting elements comprise one of suction cups and fastening strips for mounting to reciprocal fastening strips attached to said window pane.

6. The planter of claim 2, wherein said at least one flexible strand comprises one of string, rope, wire, twine, hemp, macramé, and leather.

7. The planter of claim 1, wherein said container comprises one of a plastic, ceramic, terracotta, or glass material.

8. The planter of claim 1, wherein said planter comprises stained glass or synthetic stained glass.

9. The planter of claim 1, wherein said planar surface comprises an upper flat edge which is continuous with a curved edge, said container comprising a continuous rounded surface attached to said curved edge to form a pocket for holding plants.

10. The planter of claim 1, further comprising clear synthetic soil or at least partially translucent colored synthetic soil retained within said container for potting said plants.

11. The planter of claim 1, wherein said planar surface is trapezoidal or rectangular.

12. A planter for mounting on a window pane, comprising:
a plurality of plant containers each having a pocket adapted to hold plants, each container comprising a planar surface that rests against a window pane and at least one of a ring or an aperture positioned at an upper edge of said container, said container defining a silhouette having a periphery on said window pane;
a plurality of mounting elements capable of mounting said plurality of containers onto said window pane, wherein each container is operatively connected to two of said plurality of mounting elements, said two mounting elements operatively connected to said at least one ring or aperture on said upper edge of said container, said two mounting elements attachable to said window pane from positions of attachment outside said periphery to support each container with said planar surface resting against said window pane; and
at least one flexible strand for attaching said plurality of containers to said plurality of mounting elements and hanging said plurality of containers from said plurality of mounting elements mounted to said window pane.

13. The planter of claim 12, wherein said at least one flexible strand comprises one of string, rope, wire, twine, hemp, macramé, and leather.

14. The planter of claim 12, wherein said at least one flexible strand comprises one or a pair of flexible strands corresponding to each container and attached to said two of said plurality of mounting elements.

15. The planter of claim 14, wherein said plurality of mounting elements is two mounting elements, each container being supported by said two mounting elements, and wherein said at least one flexible strand is adjustable in length thereby allowing a vertical hanging position of each of said plurality of containers from said two mounting elements to be independently adjusted.

16. The planter of claim 12, wherein said at least one flexible strand comprises an adjustable-length flexible strand comprising a draw-string and slidable locking clasp.

17. The planter of claim 12, further comprising positioning clips for locating and maintaining each container in a preferred position along said at least one flexible strand.

18. The planter of claim 12, wherein said plurality of mounting elements comprise suction cups.

19. In combination:
a planter for mounting on a window pane, comprising:
a plant container having a pocket adapted to hold plants, said container comprising an upper edge and a planar surface that rests against a window pane and at least one of a ring or an aperture positioned on said upper edge of said container for attachment to said window pane, said container defining a silhouette having a periphery on said window pane; and
at least two mounting elements operatively connected to said at least one ring or aperture on said upper edge of said container and attachable to said window pane from positions of attachment outside said periphery to support said container with said planar surface resting against said window pane;
clear synthetic soil or at least partially translucent colored synthetic soil retained within said container for potting said plants;
a measuring cup for measuring water for watering said plants in said planter; and
seeds for planting and growing said plants.
